(19) United States
(12) Patent Application Publication
(10) Pub. No.: US 2026/0218760 A1
(43) Pub. Date: Jul. 30, 2026

(54) RESILIENT DUST COVER FOR FAN CLUTCH ASSEMBLY

(71) Applicant: Volvo Truck Corporation, GÖTEBORG (SE)

(72) Inventors: Henrique AVILA, Curitiba (BR); Rogerio NALIN, Itapevi (BR)

(21) Appl. No.: 19/143,679

(22) PCT Filed: Jan. 6, 2023
(86) PCT No.: PCT/IB2023/050118

§ 371 Date: Jun. 26, 2025

(51) Int. Cl. F04D 25/02; F16D 27/14; F16D 121/18

(52) U.S. Cl. CPC F04D 25/02; F16D 27/14; F16D 2121/18; F16D 2200/0056; F16D 2200/0078; F16D 2300/26

(57) ABSTRACT

A resilient dust cover for a fan clutch assembly is provided. The fan clutch assembly includes a solenoid body, a drive shaft extending through the solenoid body, and a clutch body connected to the drive shaft. The resilient dust cover includes a resilient body having a first opening arranged to allow the resilient body to receive the solenoid body within the resilient body and to fit tightly on the solenoid body, and a second opening opposite the first opening arranged to fit loosely over the drive shaft to allow the drive shaft to rotate freely. The resilient body is formed of a resilient material, such as rubber or silicone.

### TECHNICAL FIELD

The disclosure relates generally to engine components for vehicles. In particular aspects, the disclosure relates to a dust cover for a fan clutch assembly. The disclosure can be applied in heavy-duty vehicles, such as trucks, buses, and construction equipment. Although the disclosure may be described with respect to a particular vehicle, the disclosure is not restricted to any particular vehicle or type of vehicle.

### BACKGROUND

Engine fans are commonly used to provide airflow for liquid cooling systems for thermal management of vehicles. It is desirable to control the amount of airflow through the cooling system based on various factors, such as ambient temperature, coolant temperature, engine load, etc. Accordingly, the speed of an engine fan should be controllable to provide an optimal level of airflow to the engine.

Engine fans are driven by the crankshaft of the engine. To control the operation and speed of the fan, a clutch may be provided between the rotating shaft and the fan. One type of engine fan clutch is a solenoid-controlled viscous clutch, an example of which is shown in schematic illustration in FIG. 1.

As shown in FIG. 1, a fan clutch assembly 10 includes a non-rotating solenoid body 12 having an electronically controlled solenoid 30 disposed therein. A rotating drive shaft 20 having a flange or drive nut 22 at an end thereof extends through the solenoid body 12 and is connected to a drive plate 19 that is provided within a clutch body 18 adjacent the solenoid body 12.

The drive shaft 20 is mounted to the solenoid body 12 on a bearing 15 on an input side of the solenoid body 12 opposite the clutch body 18 on an output side of the solenoid body 12. A wiring assembly 24 in the form of a solenoid body leg extends from the solenoid body 12 to allow electrical connection from the vehicle's electronic control unit (not shown) to the solenoid 30. On the output side of the solenoid body 12 (adjacent the clutch body 18), there is a gap 16 between the solenoid body 12 and the clutch body 18. The size of the gap 16 is exaggerated in FIG. 1 for illustrative purposes.

The drive shaft 20 is rotationally driven by the engine crankshaft. The drive shaft 20 is affixed to the drive plate 19 such that rotation of the drive shaft 20 causes the drive plate 19 to rotate within the clutch body 18. A viscous fluid is provided within the clutch body 18. Activation of the solenoid 30 controls flow of the viscous fluid within the clutch body 18, which controls the friction between the drive plate 19 and the clutch body 18. Thus, activation of the solenoid 30 causes the clutch body 18 to rotate in response to rotation of the drive plate 19. A fan assembly 40 is attached to the clutch body 18. The fan assembly 40 rotates in response to rotation of the clutch body 18.

### SUMMARY

According to a first aspect of the disclosure, a resilient dust cover for a fan clutch assembly is provided, where the fan clutch assembly includes a solenoid body, a drive shaft extending through the solenoid body, and a clutch body connected to the drive shaft. The resilient dust cover includes a resilient body having a first opening arranged to allow the resilient body to receive the solenoid body within the resilient body and to fit tightly on the solenoid body, and a second opening opposite the first opening arranged to fit loosely over the drive shaft to allow the drive shaft to rotate freely. The resilient body is formed of a resilient material.

The first aspect of the disclosure may seek to obstruct dust, water or other contaminants from entering the solenoid body during operation of a vehicle in which the fan clutch assembly is installed. A technical benefit may include reducing the incidence of bearing lock that could occur as a result of dust, water or other contaminants entering the solenoid body.

In an aspect, the resilient body further comprises a third opening that is arranged to allow a wiring assembly to pass through the resilient body to connect to the solenoid body. This allows electrical connection to the solenoid body.

In an aspect, the resilient dust further comprises a retention member adjacent the first opening. The retention member is arranged to hold the resilient dust cover onto the solenoid body. A technical benefit may include improved protection of the solenoid body from contaminants and/or greater resistance to vibration.

In an aspect, the retention member extends into a gap between the solenoid body and the clutch body when the resilient dust cover is installed on the fan clutch assembly. In a further aspect, the retention member comprises a circumferential lip that fits over an end of the solenoid body. A technical benefit may include improved protection of the solenoid body from contaminants and/or greater resistance to vibration.

In an aspect, the resilient dust cover is shaped to conformally form to an outer profile of the solenoid body. A technical benefit may include improved mechanical connection between the resilient dust cover and the solenoid body.

In an aspect, the resilient dust cover further comprises a rib on an inner surface of the resilient body. The rib is arranged to contact an outer surface of the solenoid body when the resilient dust cover is installed on the fan clutch assembly. In a further aspect, the rib comprises a circumferential feature that extends around an internal surface of the resilient body. In a further aspect, the rib comprises a resilient material with a first hardness and the resilient body comprises a resilient material with a second hardness that is greater than the first hardness. A technical benefit may include improved mechanical connection between the resilient dust cover and the solenoid body and/or improved protection of the solenoid body from contaminants.

In an aspect, the resilient body comprises a multi-layered material comprising an inner layer of resilient material and an outer layer of resilient material that are laminated together to form the resilient body. In a further aspect, the inner resilient layer comprises a resilient material with a first hardness and the outer resilient layer comprises a resilient material with a second hardness that is greater than the first hardness. A technical benefit may include improved mechanical connection between the resilient dust cover and the solenoid body and/or improved protection of the solenoid body from contaminants.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

Examples of inventive concepts will be described with reference to the attached drawings, in which:

FIG. 1 is a schematic illustration of a fan clutch assembly.

FIGS. 2 to 6 are schematic illustrations of fan clutch assemblies including resilient dust covers according to some examples.

FIG. 7 is a perspective drawing of a fan clutch assembly on which a resilient dust cover according to some examples may be installed.

FIG. 8 is a perspective drawing of a fan clutch assembly on which a resilient dust cover according to some examples is installed.

### DETAILED DESCRIPTION

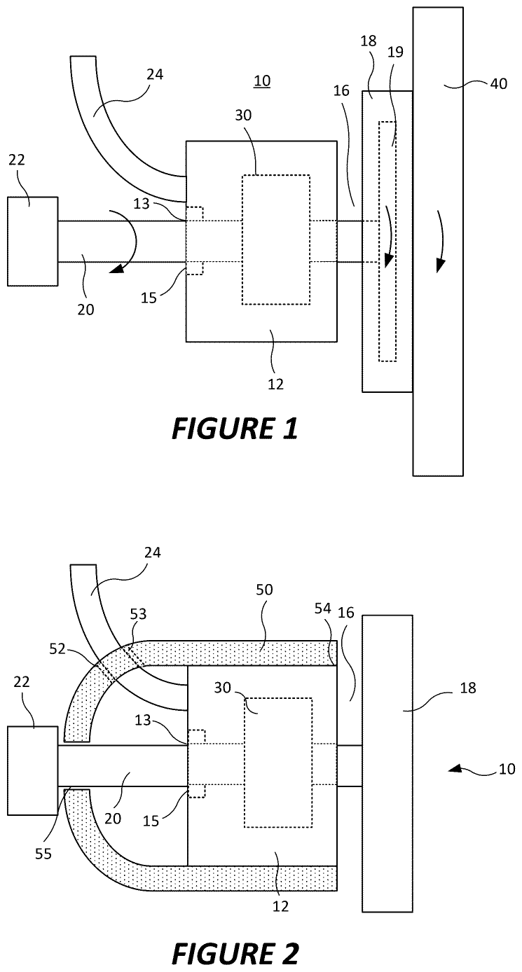

As illustrated in FIG. 1, the drive shaft 20 of a fan clutch assembly 10 is mounted to the solenoid assembly 12 on a bearing 15. Additionally, there is a gap between the non-rotating solenoid body 12 and the rotating clutch body 18. Vehicles in which the fan clutch assembly 10 may be employed, particularly heavy vehicles such as trucks and construction equipment, often operate in dirty and dusty environments, and may be subjected to high levels of vibration and mechanical stress. Due to the dusty environment, it is possible for dust, dirt or other contaminants to enter into the solenoid body around small gaps 13 in the bearing 15 near the drive shaft 20. Such contaminants may cause a bearing holding the drive shaft to lock up, which can cause the solenoid body or wiring harness to break, causing the fan to continuously engage due to lack of electrical signal.

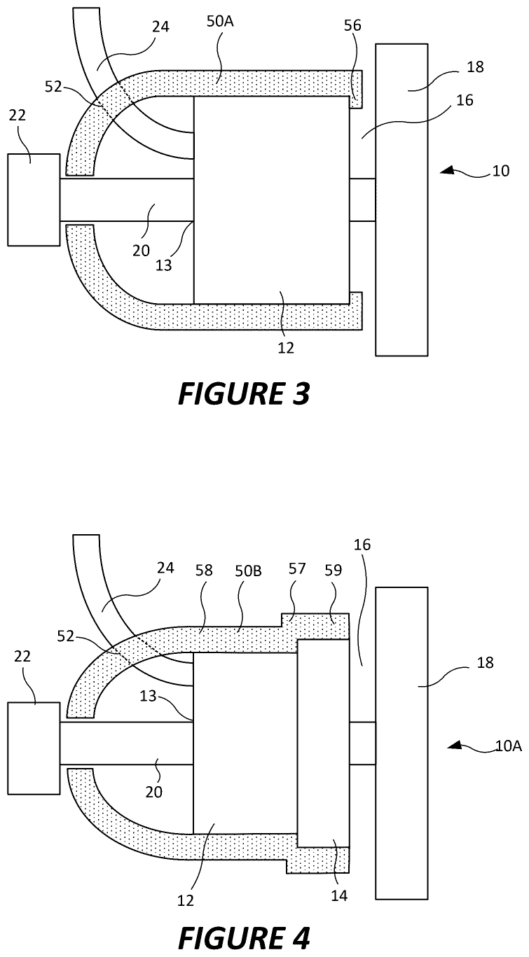

Referring to FIG. 2, some embodiments provide a resilient dust cover 50 that fits tightly over the solenoid body 12 and that protects the solenoid body 12 from intrusion by dust, water or other contaminants through gaps 13 in or around the bearing 15 and/or the gap 16 between the solenoid body 12 and the clutch body 18. The resilient dust cover 50 includes a body that is formed of a resilient material that is flexible and able to withstand impacts or deformations without breaking or cracking. Such materials may include, without limitation, rubber, silicone, polyurethane, polyethylene, polypropylene, and polyvinyl chloride (PVC). Because the resilient dust cover 50 is made of a resilient material, it may be form fit over the solenoid body 12 to provide a tight fit that can withstand vibrations, shocks, and other mechanical stresses that can be experienced within a vehicle engine compartment.

The use of a resilient dust cover 50 to protect fan clutch assembly 10 may have certain advantages over, for example, a dust cover made of a rigid material such as metal or hard plastic. In particular, a rigid dust cover may deform and/or crack when subjected to vibrations, shocks, and other mechanical stresses, which can cause openings to be formed between the dust cover and the fan assembly through which dust or other contaminants can penetrate.

The resilient dust cover 50 includes a first opening 54 that is sized to fit tightly over the solenoid body 12, a second opening 55 that is sized to fit loosely over the drive shaft 20 to allow the drive shaft 20 to rotate freely without impingement by the resilient dust cover 50, and a third opening 52 that is sized to fit tightly over the wiring assembly 24. The solenoid body 12 may have a cylindrical shape, and the first opening 54 may have an inner diameter that is slightly smaller than the outer diameter of the solenoid body 12 so that the resilient dust cover 50 fits tightly over the solenoid body 12 and may be held in place by friction. In some examples, a stronger mechanical connection may be provided between the resilient dust cover 50 and the solenoid body 12 by attaching the resilient dust cover 50 to the solenoid body 12 with a mechanical fastener, such as a hose clamp (not shown). In other examples, the resilient dust cover 50 may be attached to the solenoid body 12 using an adhesive, such as a heat resistant glue.

The resilient dust cover 50 further includes an aperture 52 through which the wiring assembly 24 may extend from the solenoid body 12. In some examples, a gasket 53 may be provided within the aperture 52 to provide a tight fit to the wiring assembly 24. The clutch body 18 and the drive shaft 20 may each rotate freely without causing mechanical stress to the wiring assembly 24.

Although the resilient dust cover 50 may not cover the inner side of bearing 15,, the inner side of the bearing 15 may be less prone to dust intrusion because it is protected by the solenoid 30 and the clutch body 18.

As is apparent from FIG. 2, the resilient dust cover 50 may be installed without removing the clutch body 18 or the fan assembly 40 from the solenoid body 12 by sliding the resilient dust cover 50 over the drive shaft 20 and onto the solenoid body 12. This means that the resilient dust cover 50 may be easily installed as an aftermarket or optional component after manufacture of a vehicle containing the fan clutch assembly 10.

FIG. 3 illustrates a resilient cover 50A for a fan clutch assembly 10 according to a further example. The resilient cover 50A is similar to the resilient cover 50 shown in FIG. 2, except that the resilient cover 50A includes a retention member 56 at an end thereof. The retention member 56 may have the form of a circumferential lip that fits over an end of the solenoid body 12 and extends into the gap 16 between the solenoid body 12 and the clutch body 18. The retention member 56 may be formed integrally with the resilient cover 50A and may be formed of the same material as the resilient cover 50A. The retention member 56 may help to hold the resilient cover 50A onto the solenoid body 12 and/or may help to further protect the bearing 15 from contaminant intrusion through the gap 16.

FIG. 4 illustrates a resilient cover 50B for a fan clutch assembly 10A according to a further example. The fan clutch assembly 10A includes a non-rotating support plate 14 affixed to the solenoid body 12. The support plate 14 has a larger diameter than the solenoid body 12. The resilient cover 50A is similar to the resilient cover 50 shown in FIG. 2, except that the resilient cover 50A includes a step 57 that allows the resilient cover 50A to conformally form to an outer profile of both the solenoid body 12 and the support plate 14. That is, the resilient cover 50B includes a first cylindrical portion 58 having a diameter that is about the same as or slightly smaller than the diameter of the solenoid body 12 and a second cylindrical portion 59 having a diameter that is about the same as or slightly smaller than the diameter of the support plate 14. Although not illustrated in FIG. 4, it will be appreciated that the resilient cover 50B may also include the retention member 56 shown in FIG. 3.

FIG. 5 illustrates a resilient cover 50C for a fan clutch assembly 10 according to a further example. The resilient cover 50C is similar to the resilient cover 50 shown in FIG. 2, except that the resilient cover 50C includes one or more ribs 62 on an inner surface thereof. The ribs 62 may be formed as circumferential features that extend completely around the inner surface of the resilient cover 50C.

The ribs 62 are positioned to contact the solenoid body 12 when the resilient cover 50C is installed onto the solenoid body 12, and may allow the resilient cover 50C to more strongly grip the solenoid body 12. The ribs 62 may also allow the resilient cover 50C to be installed onto the solenoid body more easily. The ribs 62 may be formed integrally with the resilient cover 50C and may be formed of the same material as the resilient cover 50C.

In some embodiments, the ribs 62 may be formed of a material that is different from the resilient cover 50C. For example, the resilient cover 50C may be formed of a resilient material that has a first hardness, and the ribs 62 may be formed of a material that has a second hardness that is less than the first hardness. Having a lower hardness may allow the ribs 62 to deform more when pressed against the side of the solenoid body 12, creating a tighter fit that is more resistant to mechanical vibration and/or shock. Meanwhile having a greater hardness may allow the resilient cover 50C to exert more force on the solenoid body through the ribs 62 and/or to provide greater physical protection to the fan clutch assembly 10.

Although not illustrated in FIG. 5, it will be appreciated that the resilient cover 50C may also include the retention member 56 shown in FIG. 3 and/or one or more steps 57 shown in FIG. 4.

FIG. 6 illustrates a resilient cover 50D for a fan clutch assembly 10 according to a further example. The resilient cover 50D is similar to the resilient cover 50 shown in FIG. 2, except that the resilient cover 50D is formed of a multi-layered material including, for example, a first layer 50D-1 of a first resilient material and a second layer 50D-2 of a second resilient material. The first and second layers 50D-1, 50D-2 may be laminated together with the first layer 50D-1 being an outer layer and the second layer 50D-2 being an inner layer. The first and second layers 50D-1, 50D-2 may have at least one different material characteristic. For example, the first layer 50D-1 may have a first hardness and the second layer 50D-2 may have a second hardness that is less than the first hardness.

Having a lower hardness may allow the inner second layer 50D-2 to deform more when pressed against the side of the solenoid body 12, creating a tighter fit that is more resistant to mechanical vibration and/or shock. Meanwhile having a greater hardness may allow the outer first layer 50D-1 to exert more force on the solenoid body through the inner second layer 50D-2 and/or to provide greater physical protection to the fan clutch assembly 10.

Although not illustrated in FIG. 6, it will be appreciated that the resilient cover 50D may also include the retention member 56 shown in FIG. 3, one or more steps 57 shown in FIG. 4, and/or one or more ribs 62 shown in FIG. 5.

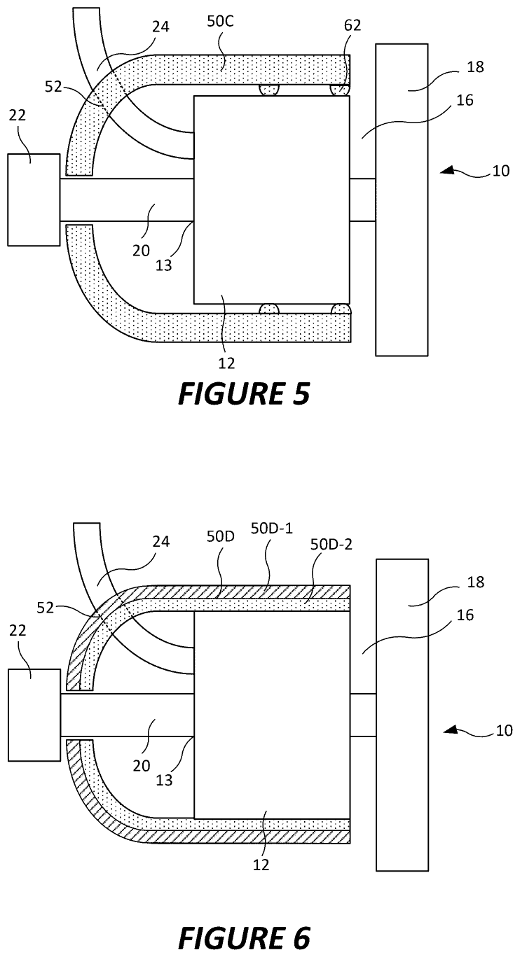

FIG. 7 is a perspective drawing of a fan clutch assembly 10 on which a resilient dust cover according to some examples may be installed. As shown in FIG. 7, the fan clutch assembly 10 includes a non-rotating solenoid body 12 having an electronically controlled solenoid disposed therein. A rotating drive shaft 20 having a flange or drive nut 22 at an end thereof extends through the solenoid body 12 and is connected to a drive plate that is provided within a clutch body 18 adjacent the solenoid body 12.

The drive shaft 20 is mounted to the solenoid body 12 on a bearing 15 on an input side of the solenoid body 12 opposite the clutch body 18. A wiring assembly 24 extends from the solenoid body 12 to allow electrical connection to/from the vehicle's electronic control unit. A fan assembly 40 is affixed to the clutch body 18.

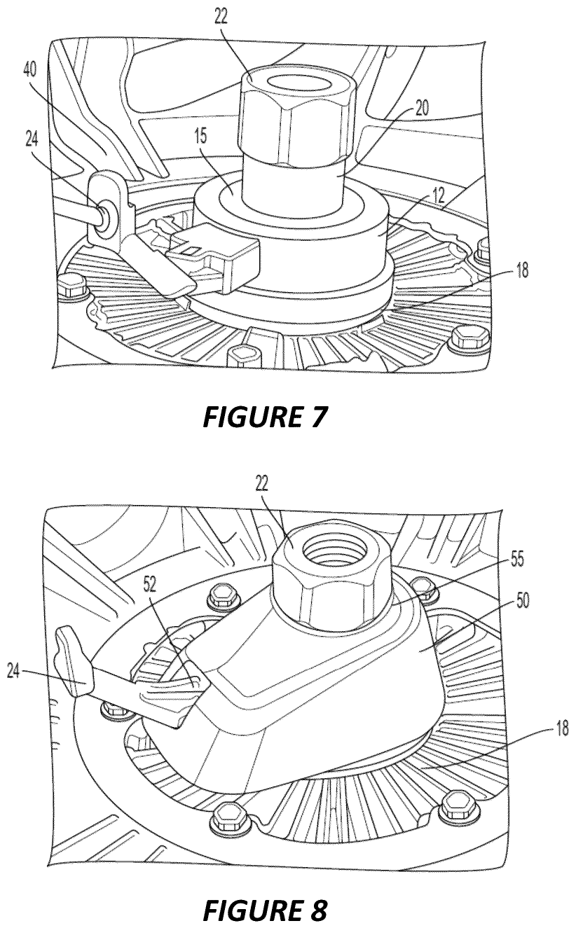

FIG. 8 is a perspective drawing of a fan clutch assembly 10 on which a resilient dust cover 50 according to some examples is installed. The resilient dust cover 50 fits onto the solenoid body 12 and includes an aperture 55 through which the drive shaft 20 extends and an aperture 52 through which the wiring assembly 24 extends.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A resilient dust cover for a fan clutch assembly, the fan clutch assembly including a solenoid body, a drive shaft extending through the solenoid body, and a clutch body connected to the drive shaft, the resilient dust cover comprising:
a resilient body comprising:
a first opening arranged to allow the resilient body to receive the solenoid body within the resilient body and to fit tightly on the solenoid body; and
a second opening opposite the first opening arranged to fit loosely over the drive shaft to allow the drive shaft to rotate freely;
wherein the resilient body is formed of a resilient material.

2. The resilient dust cover of claim 1, wherein the resilient body further comprises a third opening that is arranged to allow a wiring assembly to pass through the resilient body to connect to the solenoid body.

3. The resilient dust cover of claim 1, wherein the resilient material comprises at least one of rubber, silicone, polyurethane, polyethylene, polypropylene, and polyvinyl chloride.

4. The resilient dust cover claim 1, further comprising a retention member adjacent the first opening, wherein the retention member is arranged to hold the resilient dust cover onto the solenoid body.

5. The resilient dust cover of claim 4, wherein the retention member extends into a gap between the solenoid body and the clutch body when the resilient dust cover is installed on the fan clutch assembly.

6. The resilient dust cover of claim 4, wherein the retention member comprises a circumferential lip that fits over an end of the solenoid body.

7. The resilient dust cover of claim 1, wherein the resilient dust cover is shaped to conformally form to an outer profile of the solenoid body.

8. The resilient dust cover of claim 1, further comprising a rib on an inner surface of the resilient body, wherein the rib is arranged to contact an outer surface of the solenoid body when the resilient dust cover is installed on the fan clutch assembly.

9. The resilient dust cover of claim 8, wherein the rib is integrally formed with the resilient body.

10. The resilient dust cover of claim 8, wherein the rib comprises a circumferential feature that extends around an internal surface of the resilient body.

11. The resilient dust cover of claim 8, wherein the rib comprises a different material than the resilient body.

12. The resilient dust cover of claim 11, wherein the rib comprises a resilient material with a first hardness and the resilient body comprises a resilient material with a second hardness that is greater than the first hardness.

13. The resilient dust cover of claim 1, wherein the resilient body comprises a multi-layered material comprising an inner layer of resilient material and an outer layer of resilient material that are laminated together to form the resilient body.

14. The resilient dust cover of claim 13, wherein the inner resilient layer comprises a resilient material with a first hardness and the outer resilient layer comprises a resilient material with a second hardness that is greater than the first hardness.

15. A fan clutch assembly, comprising:
a solenoid body;
a drive shaft extending through the solenoid body;
a clutch body connected to the drive shaft; and
a resilient dust cover on the solenoid body, the resilient dust cover having a first opening adjacent the clutch body, the first opening arranged to allow the resilient dust cover to receive the solenoid body within the resilient dust cover and to fit tightly on the solenoid body, and a second opening opposite the first opening arranged to fit loosely over the drive shaft to allow the drive shaft to rotate freely, wherein the resilient dust cover is formed of a resilient material.

16. The fan clutch assembly of claim 15, wherein the resilient body further comprises a third opening that is arranged to allow a wiring assembly to pass through the resilient body to connect to the solenoid body.

17. The fan clutch assembly of claim 15, wherein the resilient material comprises at least one of rubber, silicone, polyurethane, polyethylene, polypropylene, and polyvinyl chloride.

18. The fan clutch assembly of claim 15, further comprising a retention member adjacent the first opening, wherein the retention member is arranged to hold the resilient dust cover onto the solenoid body.

19-20. (canceled)

21. The fan clutch assembly of claim 15, wherein the resilient dust cover is shaped to conformally form to an outer profile of the solenoid body.

22. The fan clutch assembly of claim 15, further comprising a rib on an inner surface of the resilient body, wherein the rib is arranged to contact an outer surface of the solenoid body when the resilient dust cover is installed on the fan clutch assembly.

23-28. (canceled)
